(19) United States
(12) Patent Application Publication
(10) Pub. No.: US 2013/0250954 A1
(43) Pub. Date: Sep. 26, 2013

(54) ON-CHIP ROUTER AND MULTI-CORE SYSTEM USING THE SAME

(71) Applicant: Toru Sano, Fujisawa-shi (JP)

(72) Inventor: Toru Sano, Fujisawa-shi (JP)

(73) Assignee: KABUSHIKI KAISHA TOSHIBA, Tokyo (JP)

(21) Appl. No.: 13/598,389

(22) Filed: Aug. 29, 2012

(30) Foreign Application Priority Data
Mar. 23, 2012 (JP) 2012-067923

(51) Int. Cl. H04L 12/56

(52) U.S. Cl. 370/392

(57) ABSTRACT

An on-chip router of the embodiments has plural input ports that receive packets, plural output ports that transmits the packets, plural buffers, each being provided so as to correspond to each of the input ports and accumulating at least a portion of the packets received through the input ports, a switching unit that switches the output destinations of the packets so that the packets are transmitted from any of the plural output ports, a header analyzer that has plural hop field extractors provided so as to correspond to each of the buffers, and a switching controller that controls the switching unit so that the packets are transmitted from an output port indicated by output port information of the hop field extracted by the hop field extractors.

### CROSS-REFERENCE TO RELATED APPLICATIONS

This application is based upon and claims the benefit of priority from the prior Japanese Patent Application No. 2012-067923, filed on Mar. 23, 2012; the entire contents of which are incorporated herein by reference.

### FIELD

Embodiments described herein relate generally to ON-CHIP ROUTER AND MULTI-CORE SYSTEM USING THE SAME.

### BACKGROUND

Multi-core systems tend to have long bus distribution to connect between a number of processor cores (hereafter simply referred to as “core”) or between the cores and memories. For that reason, it is difficult to secure wiring resources and to synchronize the timings of data transmission/reception. The maximum operating frequency of the multi-core systems is limited in order to synchronize the timings.

There is a technology referred to as a Network on Chip (NoC) as a technology to solve the above timing problem. In this technology, data is packetized as in Ethernet or other technologies, and the packet is transferred to a desired target (cores, memories) through an on-chip router (hereinafter simply referred to as “router”).

Packet transfer methods mainly include adaptive routing and source routing (also known as fixed routing). In the adaptive routing, a router that received a packet carries out route computation based on the destination address of the packet and determines the next transfer destination. The advantage of this routing method is a short header length in a packet, whereas the disadvantage is a heavy load of the route computation in relay routers.

On the other hand, in the source routing, a transmission source core (or router, initiator, or network interface) carries out all computations of a packet transfer route in advance, and stores information on the transfer route in a header. Once transfer route is determined at the beginning, the route is not dynamically changed in accordance with congestion information etc. of the route. The advantage of this routing method is a reduced load of the route computation in relay routes, whereas the disadvantage is a longer header length compared with the header length in the adaptive routing.

As described above, in the source routing, as the number of the relay routers increases, the header length of a packet becomes longer and the amount of buffer use increases, resulting in a problem of increase in latency.

### BRIEF DESCRIPTION OF THE DRAWINGS

FIG. 1 is a diagram illustrating an example of a tree topology multi-core system;

FIG. 2 is a diagram illustrating overview of the entire structure of a packet of a network on-chip;

FIG. 3 is a diagram illustrating an example of a header of a packet in source routing;

FIG. 4 is a diagram illustrating an example of a header of a packet in which route information is compressed;

FIG. 5 is a diagram illustrating a schematic configuration of a router according to the first embodiment;

FIG. 6 is a diagram illustrating a detailed configuration of a portion of the router according to the first embodiment;

FIG. 7 is a diagram illustrating an example of a header of a packet in source routing;

FIG. 8 is a diagram illustrating an example of a header of a packet in which route information is compressed;

FIG. 9 is a diagram illustrating a schematic configuration of a router according to the second embodiment;

FIG. 10 is a diagram illustrating a detailed configuration of a portion of the router according to the second embodiment;

FIG. 11 is a diagram illustrating a detailed configuration of an output port selector according to the second embodiment;

FIG. 12 is a diagram illustrating an example of a header of a packet in source routing;

FIG. 13 is a diagram illustrating an example of a header of a packet in which route information is compressed;

FIG. 14 is a diagram illustrating a detailed configuration of an output port selector according to the third embodiment; and

FIG. 15 is a diagram illustrating an example of configuration of a mesh topology multi-core system.

### DETAILED DESCRIPTION

An on-chip router of the embodiments is provided with plural input ports that receive packets, plural output ports that transmits the packets, plural buffers, each being provided so as to correspond to each of the input ports and accumulating at least a portion of the packets received through the input ports, a switching unit that switches the output destinations of the packets so that the packets are transmitted from any of the plural output ports, a header analyzer that has plural hop field extractors provided so as to correspond to each of the buffers, and a switching controller that controls the switching unit so that the packets are transmitted from an output port indicated by output port information of the hop field extracted by the hop field extractors.

Each of the hop field extractors receives an input of header information of the packet accumulated in the corresponding buffer, and extracts, from among plural hop fields that store output port information, a hop field that stores output port information indicating an output port from which the packet received through the input port is output.

The on-chip router of the embodiments is further provided with a header rewriter. The header rewriter receives an input of a packet output from the switching unit and rewrites output port information in a hop field that an on-chip router of the packet output destination uses to transfer the packet from among the plural hop fields into decoded output port information, and outputs a packet in which the output port information is rewritten to the output port.

Embodiments will now be explained with reference to the accompanying drawings.

Prior to explaining the embodiments relating to the present invention, packet transfer by using conventional source routing will be explained.

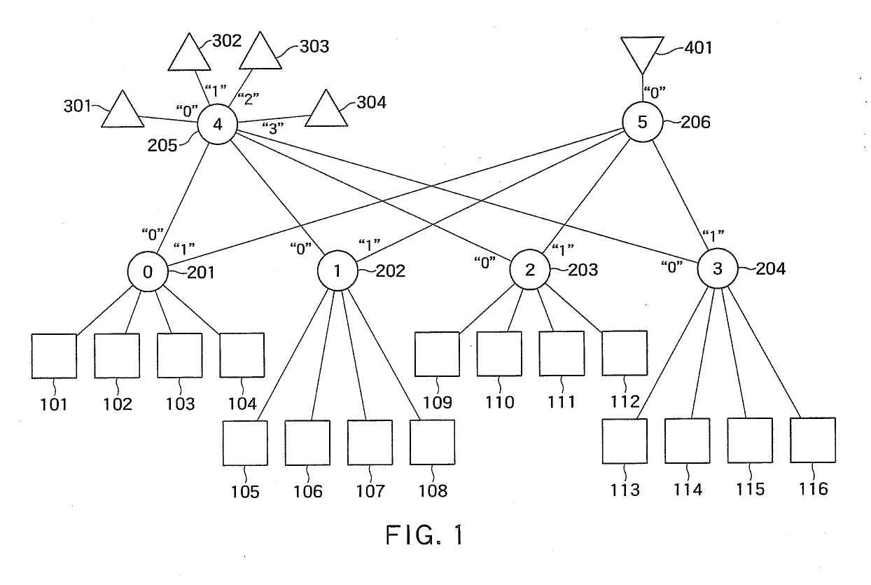

FIG. 1 illustrates an example of a tree topology multi-core system that uses a source routing Network on Chip. This multi-core system is provided with sixteen cores 101-116, six routers 201-206, four memories 301-304, and one I/O port 401. It should be noted that in FIG. 1, each number within a circle indicating a router is an identifier (ID) of the router. In other words, identifiers of the routers 201-206 are 0-5, respectively.

The cores 101-116 are connected to the memories 301-304 and the I/O port 401 through the routers 201-206. For example, the cores 101-104 are connected to the memories 301-304 through the router 201 and the router 205.

The cores 101-116 transmit a request packet to request reading and writing etc. to the memories 301-304. A memory that received the packet replies the packet that stores read data etc. to the source core that transmitted the request packet.

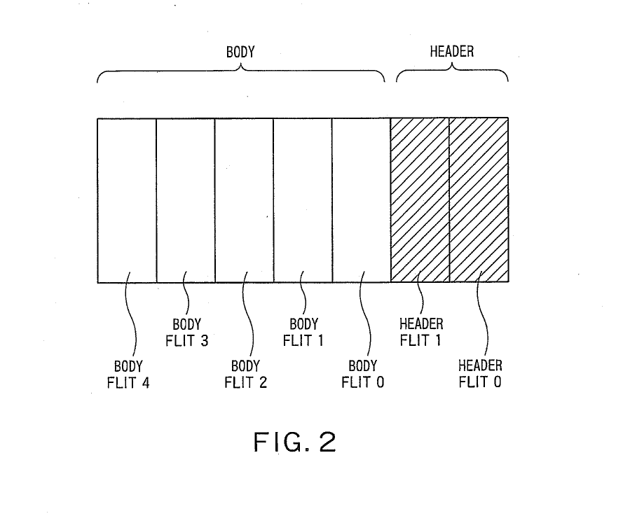

FIG. 2 illustrates the entire structure of a packet used in communications of the multi-core system. The packet is composed of a header in which information on the destination or transfer routes is stored and a body in which write data or read data etc. is stored. Both the header and the body are composed of data units referred to as “flit”. It should be noted that bit width per flit is equal to bit width in the core as an example, but it is not limited to this number. In the example in FIG. 2, the header is composed of two header flits 0 and 1, and the body is composed of five body flits 0-4. The source core or a router that first received the request packet from a core or a memory generates a packet illustrated in FIG. 2.

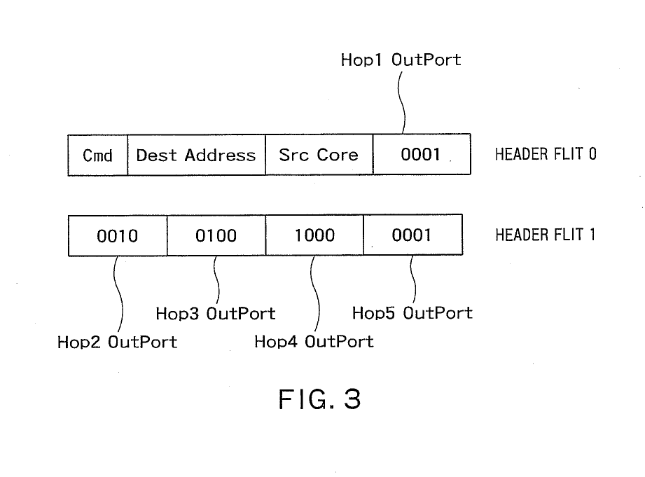

FIG. 3 illustrates an example of a packet header. The header flit 0 includes a command field (Cmd), a destination address field (Dest Address), a source core field (Src Core), and a hop field (Hop1 OutPort). The header flit 1 includes four hop fields (Hop2-Hop5 OutPort).

“Cmd” denotes a command field that indicates types of the packet (such as a read request, a write request, a read response, and a write response). “Dest Address” denotes a destination address field that stores destination addresses of the memories. “Src Core” denotes a source core field that stores an identifier of the source core transmitting a request packet.

“Hop OutPort” denotes a hop field that stores output port information. The output port information indicates an output port to output a received packet, and is, for example, an output port number. In the example of FIG. 3, output port information in one-hot encoded format is stored. In this case, the number of bits in the hop field is equal to the number of output ports. In the present embodiment, a packet is output from an output port in which the bit is “1”. For example, output port information “0001” indicates that a packet is output from an output port with the port number 0 and “0100” indicates that a packet is output from an output port with the port number 2. In FIG. 1, reference numerals “0”, “1” . . . denote the output port numbers. For example, the router 201 is connected to the router 205 through the output port “0”, and the router 205 is connected to the memory 303 through the output port “2”.

In the source routing, as the number of relay routers increases, the number of hop fields increases. For that reason, the header length tends to become longer as the number of the relay router increases.

A router that first received a packet from the source core determines an output destination of the packet by referring to the output port information stored in “Hop1. OutPort”. In the example of FIG. 3, the router that first received the packet transmits a packet form the output port of the port number “0”. The second router refers to “Hop2 OutPort” and transmits a packet from the output port of the output port number “1”. In the same manner, each of the third, the fourth, and the fifth routers transmits a packet from output ports of the output port numbers “2”, “3”, and “0”, respectively.

In the following description, embodiments according to the present invention will be explained with reference to the accompanying drawings. Note that in each of the drawings, the same reference numerals are assigned to the components having equivalent functions and detailed explanations of the components with the same reference numerals will not be repeated.

### First Embodiment

In the first embodiment, a packet that stores encoded output port information in the hop field is used. A router that received the packet decodes only output port information that will be used in a router in the next stage, rewrites the output port information in one-hot encoded format, and afterward transmits the output port information to the router in the next stage. As a result, it is possible to reduce processing time for packet transfer by determining the output port promptly while making the header length of a packet as short as possible.

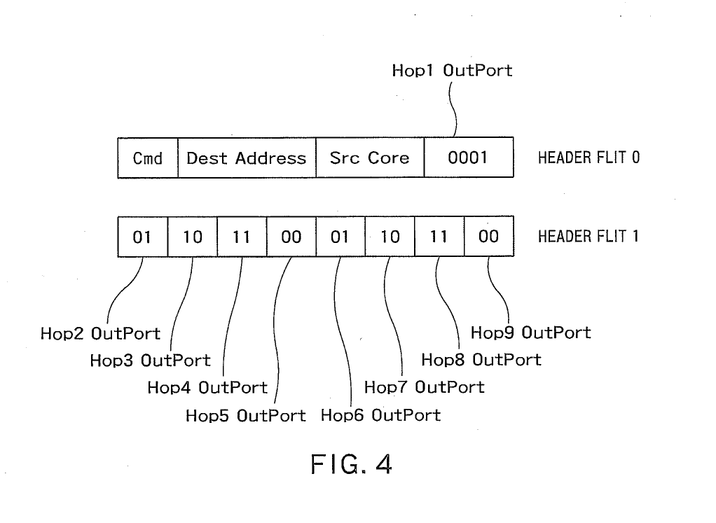

FIG. 4 illustrates an example of a packet header in which route information is compressed, and the packet header is used in the first embodiment. The “Hop1 OutPort” used by the first router stores the output port information in one-hot encoded format and the “Hop2-9 OutPort” used by the second and the subsequent routers store the output port numbers in, for example, hexadecimal notation. In other words, the output port information stored in hop fields other than the hop field used in the first transfer is encoded. For that reason, under condition of the same number of relay routers, it is possible to reduce the header length compared with that of the packet explained in FIG. 3.

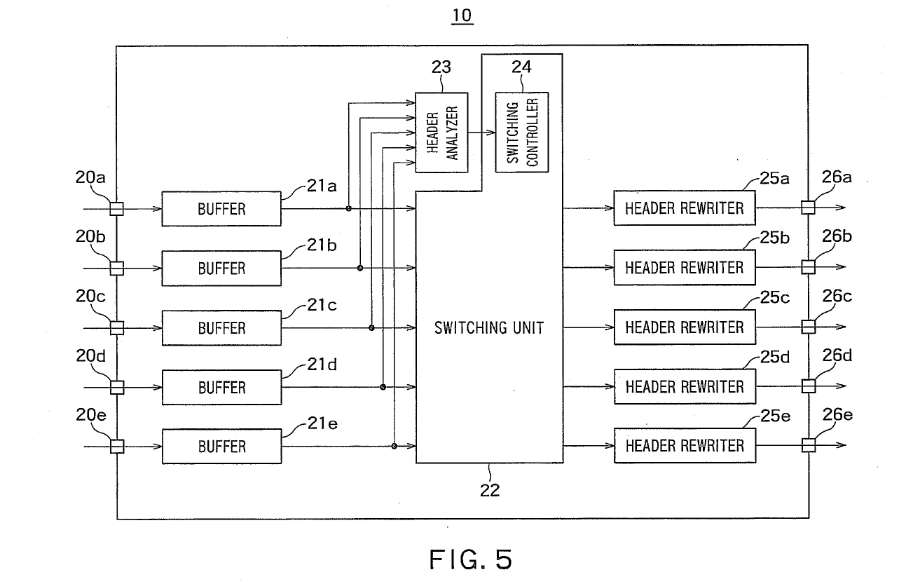

Next, a schematic configuration of a router 10 according to the first embodiment will be explained with reference to FIG. 5. FIG. 5 is a diagram illustrating schematic configuration of the router 10. The router 10 is a five-input five-output router and includes an input port unit, a switching unit 22, a header analyzer 23, a switching controller 24, header rewriters 25a-25e, and output ports 26a-26e for outputting packets. Here, the input port unit includes input ports 20a-20e for receiving packets and buffers 21a-21e for temporarily storing the received packets.

Each of the buffers 21a-21e is provided so as to correspond to the input ports 20a-20e, respectively, and accumulates at least a portion of the packets received through the input ports. It should be noted that the buffers have a capacity of one flit or more. The switching unit 22 inputs a packet from the buffers 21a-21e, and switches the output destinations of the packet so that the packet is transmitted from one of the output ports 26a-26e. The switching unit 22 selects any one of the output ports 26a-26e based on the output port information in the hop field extracted by the header analyzer 23 and switches to the output port.

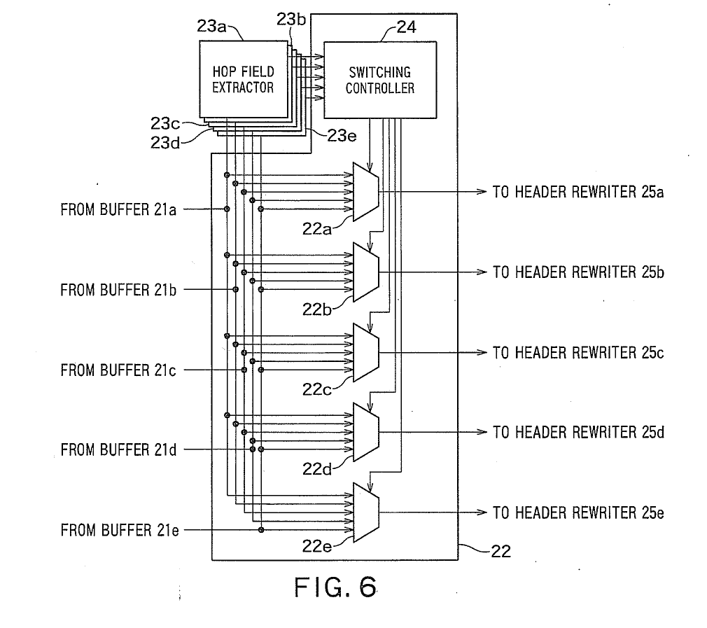

FIG. 6 is a diagram illustrating a detailed configuration of a portion of the router 10 according to the first embodiment. The header analyzer 23 extracts a hop field used in the own router from header information of a packet. The header analyzer 23 also includes plural hop field extractors 23a-23e provided so as to correspond to the buffers 21a-21e, as illustrated in FIG. 6. As a result of providing as many hop field extractors as the number of the input ports, it becomes possible to transfer packets even when plural input ports receive packets at the same time and to transmit packets from plural output ports simultaneously.

The hop field extractor extracts a hop field that stores the output port information used in the own router from the header information of a packet accumulated in the corresponding buffer. In FIG. 1, when the core 101 transmits a request packet to the memory 301, for example, the hop field extractor 23a in the router 201 extracts the “Hop1 OutPort”, and the hop field extractor 23a in the router 205 extracts the “Hop2 OutPort”.

The switching controller 24 controls the switching unit 22 so that a packet is transmitted from the output port indicated by the output port information of the hop field extracted by the hop field extractors 23a-23e. The switching controller 24 generates a selection signal by using the output port information in the extracted hop field.

The header rewriters 25a-25e decode the output port information in a hop field that is used for packet transfer by an on-chip-router that is the output destination of the packet (i.e., the router in the next stage) from among the plural hop fields of the input packet. The header rewriters output, to the selected output port, a packet in which the output port information in the hop field used by the router in the next stage is rewritten into the decoded output port information. It should be noted that the decoding processing of the output port information can be carried out in parallel with the processing of data stored in the body flit of the packet. For that reason, the decoding processing does not cause the increase in latency.

Meanwhile, the header rewriters may delete the hop field used for packet transfer in order to make the header length as short as possible. In the case of the aforementioned example, the header rewriter 25a of the router 201 deletes “Hop1 OutPort” so that the hop fields of “Hop2 OutPort” and the subsequent hop fields are moved toward the beginning of the header.

Next, detailed configurations of the switching unit 22, the header analyzer 23 (hop field extractors 23a-23e) and the switching controller 24 will be explained by using FIG. 6.

The switching unit 22 includes multiplexers 22a-22e, which is provided so as to correspond to the output port 26a-26e, respectively. Each of the multiplexers 22a-22e is connected to all of the buffers 21a-21e.

Each of the hop field extractors 23a-23e analyzes the header information of the packets accumulated in the corresponding one of the buffer 21a-21e and transmits the output port information (one-hot encoded format) stored in the extracted hop field to the switching controller 24.

The switching controller 24 generates a selection signal by using the output port information in one-hot encoded format and transmits the signal to the multiplexers. The multiplexers outputs the packet accumulated in any of the buffers 21a-21e to the header rewriter connected to the corresponding output port based on the selection signal generated in the switching controller 24.

It should be noted that the switching controller 24 preferably has a function to arbitrate the use of the output ports. In other words, when plural packets are received through different input ports and those packets have the same output destination, the switching controller 24 controls the switching unit 22 so that those packets are transmitted on the basis of a prescribed rule. For example, the switching unit 22 is controlled so as to output the received plural packets in order of a packet accumulated in the buffer 21a, a packet in buffer 21b, a packet in the buffer 21c, a packet in the buffer 21d, a packet in the buffer 21e, a packet in the buffer 21a, . . . . Another rule may be such that by setting the priority of each input port, the switching unit 22 may be controlled so that a packet received through an input port with higher priority is more preferentially transmitted. Or by setting the priority of each packet, the switching unit 22 may be controlled so that a packet with higher priority is more preferentially transmitted. In the first embodiment, the header length is reduced by storing the encoded output port information in the hop field. Furthermore, the output port information in the hop field that is used by the router in the next stage is written into decoded information (i.e., information in one-hot encoded format) and is transmitted to the router in the next stage. In other words, the output port information used in the own router had been rewritten in a decoded one-hot encoded format in the router in the previous stage. Consequently, the router that received a packet does not need to decode the output port information in the header analyzer 23 and can promptly determine the output port. In addition, when the hop field used in the own router is deleted, the header length is not increased by the decoding. As a result, according to the first embodiment, it is possible to make the header length as short as possible and to reduce the latency. Furthermore, because the decoding processing in the header analyzer 23 is no longer necessary, the header analyzer 23 and the switching controller 24 can be realized with simple and high-speed circuits.

The second and third embodiments that will be explained below compress route information in a packet by using the traffic bias in a network.

### Second Embodiment

The second embodiment uses a packet provided with a valid flag indicating validity/invalidity of the hop field. A router that received the packet transmits the packet from a default output port when a valid hop field is not present in the header of the received packet.

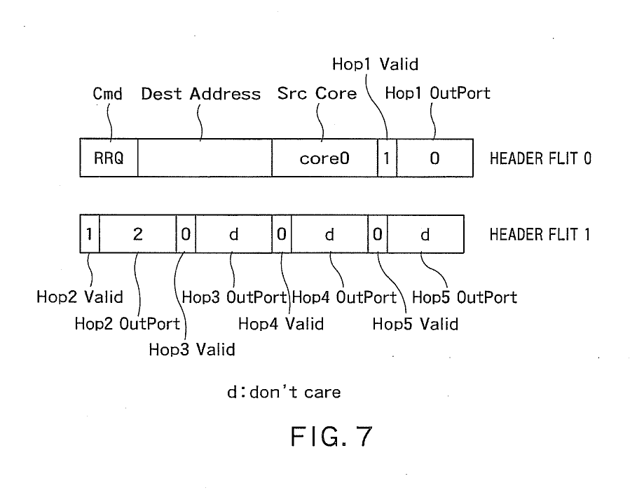

FIG. 7 illustrates an example of the packet header provided with valid flags corresponding to every hop fields. A valid flag is provided before each of the hop fields. In this example, a valid flag being “1” indicates that the corresponding hop field is valid, and a valid flag being “0” indicates that the corresponding hop field is invalid.

FIG. 7 is an example of a packet used when the core 101 makes a read request to the memory 303. “RRQ” in the command field indicates read request (Read ReQuest) and “core0” in the source core field indicates an identifier of the core 101. In addition, “Hop1 OutPort” and “Hop2 OutPort” are valid and “Hop3-5 OutPort” is invalid.

A router that received a packet, when a valid flag of a hop field corresponding to the own router indicates as valid, outputs the packet from the corresponding output port based on the output port information stored in the hop field. Meanwhile, when the valid flag indicates as invalid, the packet is output from the default output port.

In the following description, operations when the packet in FIG. 7 is received will be explained. The router 201 that received a packet from the core 101 refers to “Hop1 Valid”. The “Hop1 OutPort” is valid, because the “Hop1 Valid” is “1”. The router 201 transmits the packet to the router 205 from the output port “0” indicated by the output port information stored in the “Hop1 OutPort”. The router 205 that received the packet refers to the “Hop2 Valid”. The “Hop2 OutPort” is valid, because the “Hop2 Valid” is “1”. The router 205 transmits the packet to the memory 303 from the output port “2” indicated by the output port information stored in the “Hop2 OutPort”.

In the meantime, when a prescribed application is operated, a core makes frequent access to a particular memory etc., and this causes packets to frequently route through a particular route. In such a case, the router controls the switching unit so as to output the packets from a particular (default) output port. For example, this particular output port in each router is set to “0”. Here, this particular output port may be set in each router.

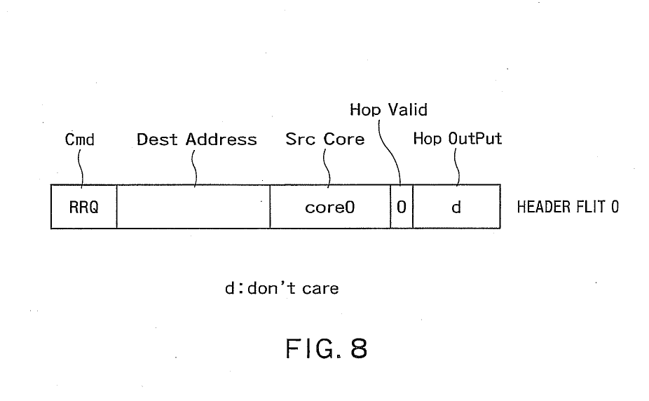

FIG. 8 illustrates an example of a packet header in which the route information is compressed. The “Hop Valid” stores “0”, which indicates that the “Hop OutPort” is invalid. It should be noted that the information stored in “Hop OutPort” is “don't care”.

Operations carried out when the packet in FIG. 8 is received will be explained. Firstly, the router 201 that received the packet from the core 101 determines whether or not a valid hop field is present. As a result of the determination, since a valid hop field is not present in the header, the router 201 transmits the packet to the router 205 from the default output port “0”. The router 205 carries out the same processing as that of the router 201.

Because a valid hop field is not present, the router 205 transmits the packet from the output port “0” to the memory 301.

In the second embodiment, valid flags indicating validity/invalidity are provided to hop fields, and when a valid hop field is not present, a packet is transmitted from the default output port. As a result, when a packet is output from the default output port, route information can be omitted, and the header length of the packet can be reduced.

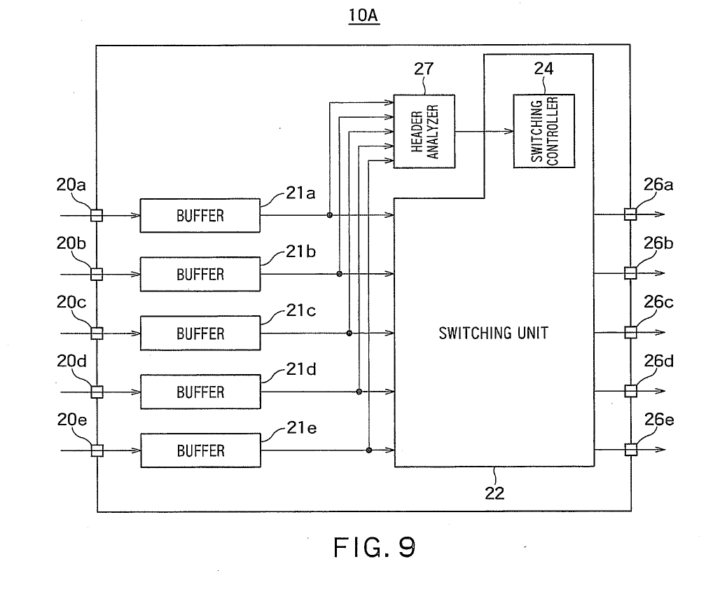

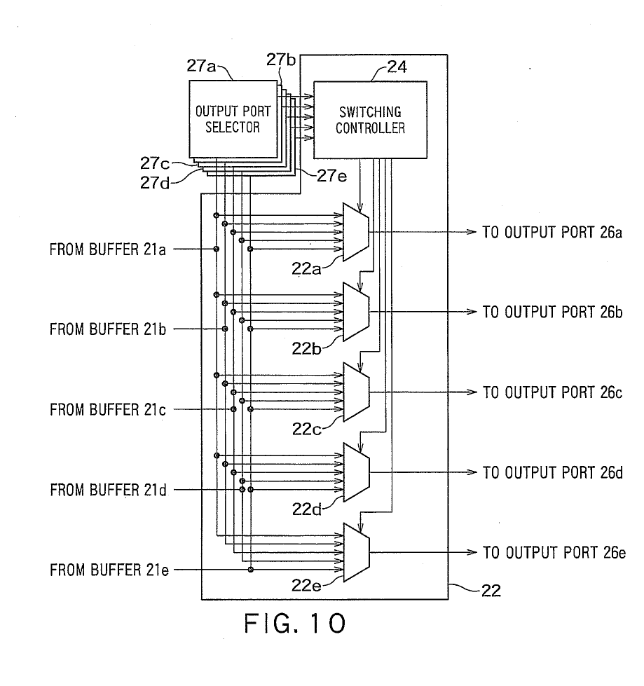

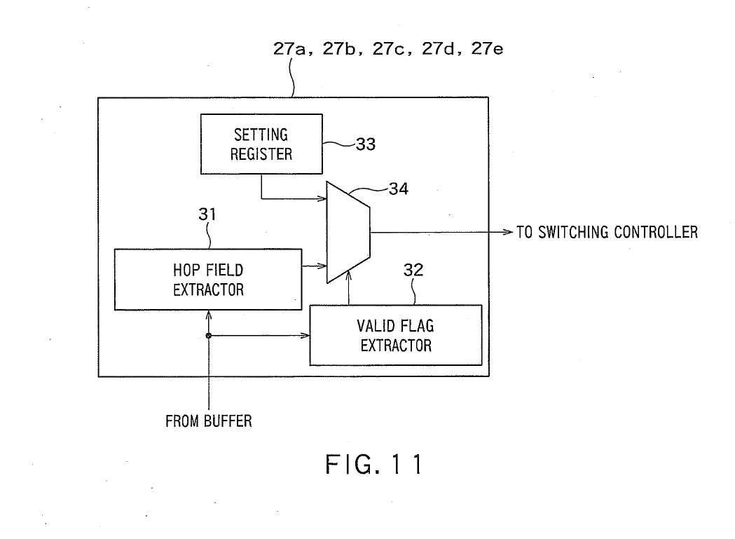

Next, an example of a router configuration according to the second embodiment will be explained by using FIG. 9 to FIG. 11. FIG. 9 illustrates a schematic configuration of a router 10A according to the second embodiment. FIG. 10 illustrates configurations of the switching unit 22, the header analyzers (output port selectors 27a-27e) and the switching controller 24. FIG. 11 illustrates a detailed configuration of the output port selector 27a-27e.

The router 10A in FIG. 9 is a five-input five-output router and has input ports 20a-20e, buffers 21a-21e, a switching unit 22, a header analyzer 27, a switching controller 24, and output ports 26a-26e. In the following description, only the configurations that are different from those in the first embodiments will be explained.

The switching controller 24 illustrated in FIG. 10 generates a selection signal by using output port information selected by the output port selectors 27a-27e.

The header analyzer 27 has the output port selectors 27a-27e, each of which is provided to correspond to each of the buffers 21a-21e. In this manner, as a result of providing the output port selectors so that the number of the output port selectors is the same as the number of the input ports, it becomes possible to transfer packets and to transmits the packet from plural output ports at the same time even when plural input ports receive packets at the same time.

An output port selector determines whether the valid flag of the hop field corresponding to the own router is valid or invalid from the header information of the packet accumulated in the corresponding buffer. When the valid flag of the hop field corresponding to the own router indicates as valid, the output port information stored in the hop field is selected. On the other hand, when a valid hop field is not present in the header, the default output port information is selected.

As illustrated in FIG. 11, each of the output port selectors 27a-27e has a hop field extractor 31, a valid flag extractor 32, a setting register 33, and a multiplexer 34. The hop field extractor 31 extracts a hop field “HopX OutPort” corresponding to the own router from a packet header. The valid flag extractor 32 extracts the valid flag “HopX Valid” corresponding to the own router from the packet header. The setting register 33 stores default output port information. Here, the default output port information may be a fixed value or may be set by a core as needed. The latter case is effective when, for example, traffic bias changes in accordance with the types of applications operated on the multi-core system. In addition, the default output port information could be an invalid identifier if default setting is not necessary.

The multiplexer 34 outputs the output port information from the hop field extractor 31 or the setting register 33 to the switching controller 24 in accordance with a signal indicating validity/invalidity from the valid flag extractor 32. More specifically, the multiplexer 34 outputs a signal of the hop field extractor 31 when “1” is input from the valid flag extractor 32, and outputs a signal from the setting register 33 when “0” is input from the valid flag extractor 32.

As explained above, in the second embodiment, the route information stored in a header is compressed by using the access traffic bias. As a result, the header length of a packet can be reduced and the latency at the time of accessing a memory or an I/O port can be also reduced. Furthermore, the power consumption can be reduced.

It should be noted that the router according to the second embodiment may have a header rewriter that deletes a hop field storing the output port information used for packet transfer in the switching unit. This header rewriter transmits the packet from which the hop field is deleted to an output port. As a result, the header length can be reduced every time a packet routes through a router.

### Third Embodiment

In the third embodiment, a router identifier field is provided instead of a valid flag. When an output port is designated in a router, an identifier of the router is stored in the router identifier field, and output port information is stored in the corresponding hop field. Meanwhile, in case of a (default) router in which an output port is not designated, an invalid router identifier is stored in the router identifier field, or a router identifier field is not used.

When a router receives a packet, the router searches for a router identifier field that stores its own identifier. When a router identifier field that stores its own identifier is found as a result of the search, the router transmits the packet from the output port stored in the corresponding hop field. On the other hand, when a field that stores the identifier of the own router is not found, the router transmits the packet from the default output port.

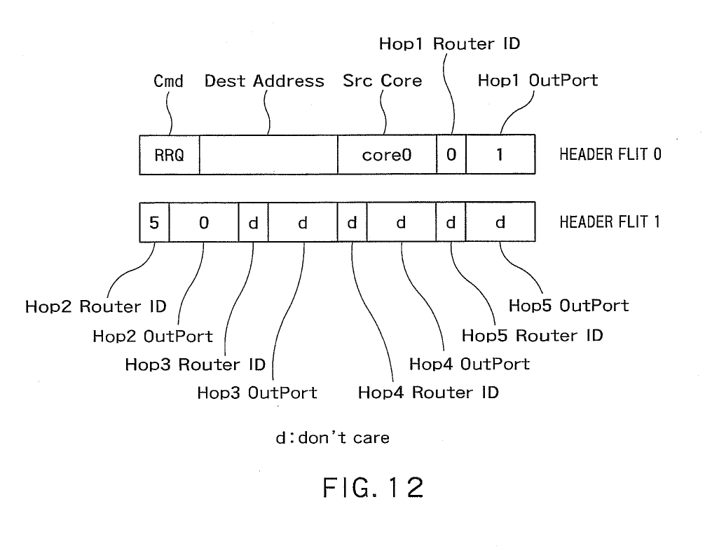

In the following description, operations carried out when a packet in FIG. 12 is received. FIG. 12 illustrates an example of a packet header provided with a router identifier field (HopX Router ID) corresponding to each of the hop fields. The router identifier field stores identifiers of routers that use the corresponding hop field. Here, the “HopX Router ID” that does not designate any particular output port stores an invalid router identifier.

The packet in FIG. 12 is an example of a packet used when the core 101 makes a read request to the I/O port 401 in FIG. 1. The router 201 searches for the same value as its own identifier “0” stored in the router identifier field. Because the value in the “Hop1 Router ID” matches the own identifier, the router 201 transmits the packet to the router 206 from the output port “1” stored in the “Hop1 OutPort”. The router 206 searches in the router identifier fields. Because the value of “Hop2 Router ID” matches the own identifier “5”, the router 206 transmits the packet to the I/O port 401 from the output port “0” stored in the “Hop2 OutPort”.

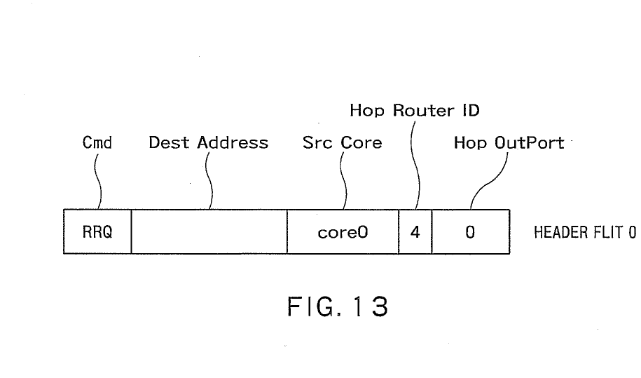

In the following description, operations carried out when a packet in FIG. 13 is received. FIG. 13 illustrates an example of a packet header in which route information is compressed. The “Hop Router ID” stores “4”, and the “Hop OutPort” stores “0”. It is assumed that the packet in FIG. 13 was transmitted from the core 101 to the router 201.

Firstly, the router 201 searches in router identifier fields. When the router identifier field that matches its own identifier is not found as a result of the search, the router 201 transmits the packet to the router 205 from the default output port “0”. The router 205 searches in the router identifier field. When a router identifier field “Hop Router ID” that matches its own identifier is found as a result of the search, the router 205 transmits the packet to the memory 301 from the output port “0” stored in the corresponding “Hop OutPort”. In this manner, packets transmitted from the core 101 are transferred to the memory 301.

In the third embodiment, a frequently-accessed output port on a route is set to default, and the packet route information is, omitted. As a result, it is possible to transfer packets by using packets with a short header length.

Next, regarding a configuration of a router according to the third embodiment, only the difference from the router according to the second embodiment will be explained. The router according to the third embodiment has a header analyzer 28 instead of the header analyzer 27 in the router 10A. This header analyzer 28 has plural output port selectors 28a-28e provided so as to correspond to buffers 21a-21e, respectively.

An output port selector, if a router identifier field storing an identifier identical with the identifier of the own router is present in the received packet header, selects the output port information stored in the hop field corresponding to the router identifier field, or if not, selects the default output port information.

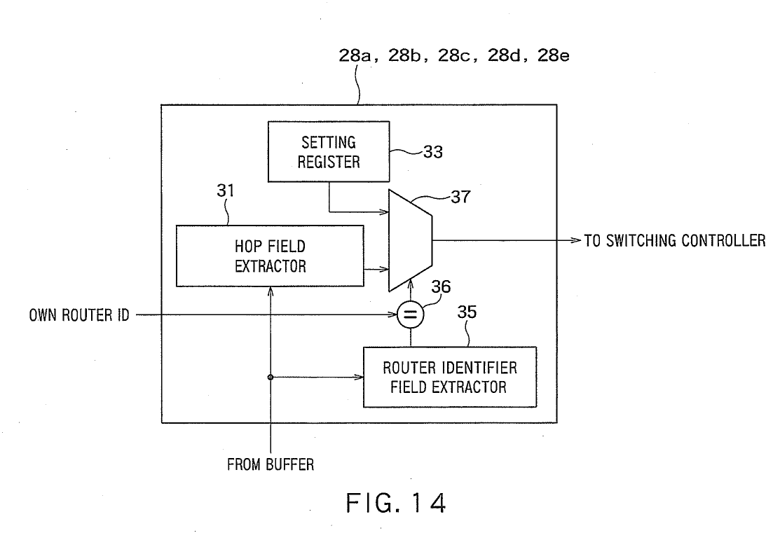

FIG. 14 is a diagram illustrating a configuration of the output port selector. Each of the output port selectors 28a-28e has a hop field extractor 31, a setting register 33, a router identifier field extractor 35, a comparator 36, and a multiplexer 37. The hop field extractor 31 and the setting register 33 are the same as those in the second embodiment, and therefore the explanations are omitted.

The router identifier field extractor 35 extracts a value of an identifier stored in a router identifier field from a header. When the header includes plural router identifier fields, the router identifier field extractor 35 extracts all of the values of the identifiers stored in every router identifier fields.

The comparator 36 compares the extracted value with the identifier of the own router, outputs “1” when the two values match, and outputs “0” when the two values do not match. When the router identifier field extractor 35 extracted plural values, the comparator 36 searches for a value that matches the identifier of the own router, outputs “1” when the value that matches the identifier of the own router is found, and outputs “0” when the value is not found.

The hop field extractor 31 extracts a hop field corresponding to the router identifier field that stores the own router ID.

The multiplexer 37 outputs the output port information of the hop field extractor 31 or the setting register 33 to the switching controller 24 in accordance with the signal from the comparator 36. More specifically, the multiplexer 37 outputs the output port information from the hop field extractor 31 when “1” is input from the comparator 36, and outputs the output port information from the setting register 33 when “0” is input from the comparator 36.

According to the third embodiment, an output port is determined by whether or not the own identifier is present in a header. In other words, the setting of the router identifier field can be omitted in an output to an output port that can be set as default. For example, in FIG. 1, when the core 101 frequently accesses to any of the memories 301-304, the core 101 omits route setting to the router 205, and sets an identifier “4” of the router 205 to the router identifier field, and generates a packet that stores port number information of the output destination in the corresponding hop field. As described above, in the third embodiment; an output port can be individually designated for any section of a packet transfer route.

It should be noted that the router according to the third embodiment may have a header rewriter that deletes a hop field storing the output port information used for packet transfer in the switching unit. This header rewriter transmits the packet from which the hop field is deleted to an output port. As a result, the header length can be reduced every time a packet routes through a router.

As explained above, in a multi-core system having a bias in access frequency only in a portion of the packet transfer route, the third embodiment can compress the route information stored in a header by using access traffic bias. As a result, the header length of a packet can be reduced and the latency at the time of accessing a memory or an I/O port can be also reduced. Furthermore, the power consumption can be reduced.

Three embodiments according to the present invention were explained above. The second and third embodiments, more generally, select an output port based on a determination field (the valid flag or the router identifier field) corresponding to a hop field. In other words, the header analyzer (the output port selector) analyzes the header information of a received packet and selects default output port information or output port information stored in a hop field based on the determination field.

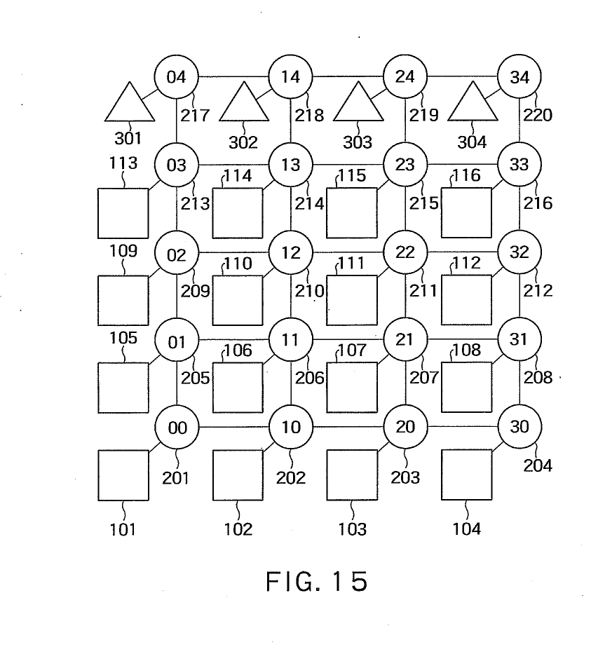

It should be noted that the network configuration of the multi-core system of the present invention is not limited to the tree topology illustrated in FIG. 1, but can be a mesh topology illustrated in FIG. 15. A multi-core system in FIG. 15 includes cores 101-116, routers 201-220, and memories 301-304. The routers 201-220 are arranged in a grid pattern and configure a mesh topology network. In such a case, a router identifier designates horizontal and vertical position (x coordinate, y coordinate) of a router so that the router can obtain its own location in the network and a location of a transfer destination.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An on-chip router comprising:
an input port unit configured to receive packets;
a plurality of output ports configured to transmit the packet;
a header analyzer configured to extract a hop field storing output port information indicating an output port of the packet from header information of the packet;
a switching unit configured to select any one of the output ports based on the output port information in the extracted hop field; and
a header rewriter configured to decode output port information of a hop field used to transfer the packet by an on-chip router that is an output destination of the packet, and to output a packet in which the output port information of the hop field is rewritten into the decoded output port information to the selected output port.

2. The on-chip router of claim 1 wherein
the input port unit comprises:
a plurality of input ports; and
a plurality of buffers, each configured to correspond to each of the input ports and accumulating at least a portion of the packet.

3. The on-chip router of claim 2 wherein
the switching unit comprises:
a switching controller configured to generate a selection signal by using the output port information in the extracted hop field; and
a plurality of multiplexers, each configured to correspond to each of the output ports,
wherein each of the multiplexers outputs the packet accumulated in any one of the buffers to the header rewriter connected to the corresponding output port based on the selection signal.

4. The on-chip router of claim 1 wherein
the header rewriter deletes the hop field that stores the output port information used in the switching unit.

5. The on-chip router of claim 1 wherein
when the output destinations of the packets received by the input port unit are the same, the switching unit selects the output port so that the packets are transmitted on the basis of a prescribed rule.

6. An on-chip router comprising:
an input port unit configured to receive packets;
a plurality of output ports configured to transmit the packet;
a header analyzer configured to select a default output port information or an output port information stored in a hop field based on a determination field corresponding to the hop field in which the output port information indicating an output port of the packet is stored; and
a switching unit configured to select any one of the output ports based on the selected output port information.

7. The on-chip router of claim 6 wherein
the input port unit comprises:
a plurality of input ports; and
a plurality of buffers, each configured to correspond to each of the input ports and accumulating at least a portion of the packet.

8. The on-chip router of claim 6 wherein
the default output port information is an invalid identifier.

9. The on-chip router of claim 6 wherein
the determination field is a valid flag indicating whether the corresponding hop field is valid or invalid, and
the header analyzer selects the default output port information when a valid hop field is not present.

10. The on-chip router of claim 9 wherein
the input port unit comprises:
a plurality of input ports; and
a plurality of buffers, each configured to correspond to each of the input ports and accumulating at least a portion of the packet.

11. The on-chip router of claim 10 wherein
the switching unit comprises:
a switching controller configured to generate a selection signal by using the selected output port information; and
a plurality of multiplexers, each configured to correspond to each of the output ports,
wherein each of the multiplexers outputs the packet accumulated in any one of the buffers to the corresponding output port based on the selection signal.

12. The on-chip router of claim 9 further comprising a header rewriter configured to transmit the packet to the output port after deleting the hop field storing the output port information used in the switching unit.

13. The on-chip router of claim 9 wherein
when the output destinations of the packets received by the input port unit are the same, the switching unit selects the output port so that the packets are transmitted on the basis of a prescribed rule.

14. The on-chip router of claim 6 wherein
the determination field is a router identifier field storing an identifier of an on-chip router, and
the header analyzer selects the output port information stored in the hop field corresponding to the router identifier field when the router identifier field storing an identifier that is equal to an identifier of own router, or otherwise selects the default output port information.

15. The on-chip router of claim 14 wherein
the input port unit comprises:
a plurality of input ports; and
a plurality of buffers, each configured to correspond to each of the input ports and accumulating at least a portion of the packet.

16. The on-chip router of claim 15 wherein
the switching unit comprises:
a switching controller configured to generate a selection signal by using the selected output port information; and
a plurality of multiplexers, each configured to correspond to each of the output ports,
wherein each of the multiplexers outputs the packet accumulated in any one of the buffers to the corresponding output port based on the selection signal.

17. The on-chip router of claim 14 further comprising a header rewriter configured to transmit the packet to the output port after deleting the hop field storing the output port information used in the switching unit.

18. The on-chip router of claim 14 wherein
when the output destinations of the packets received by the input port unit are the same, the switching unit selects the output port so that the packets are transmitted on the basis of a prescribed rule.

19. A multi-core system including a processor core, an on-chip router, and a memory, wherein
the on-chip router comprising:
an input port unit configured to receive packets;
a plurality of output ports configured to transmit the packet;
a header analyzer configured to select a default output port information or an output port information stored in a hop field based on a determination field corresponding to the hop field in which the output port information indicating an output port of the packet is stored; and
a switching unit configured to select any one of the output ports based on the selected output port information.

20. The multi-core system of claim 19 wherein
the network configuration of the multi-core system is a tree or mesh topology.
